(19) United States
(12) Patent Application Publication
(10) Pub. No.: US 2017/0045844 A1
(43) Pub. Date: Feb. 16, 2017

(54) ENDLESS BELT AND METHOD FOR MANUFACTURING THE ENDLESS BELT

(71) Applicant: FUJI XEROX CO., LTD., Tokyo (JP)

(72) Inventor: Futoshi TAKEI, Kanagawa (JP)

(73) Assignee: FUJI XEROX CO., LTD., Tokyo (JP)

(21) Appl. No.: 15/141,895

(22) Filed: Apr. 29, 2016

(30) Foreign Application Priority Data
Aug. 14, 2015 (JP) 2015-160072

(51) Int. Cl. B32B 9/04

(52) U.S. Cl. CPC G03G 15/162; B05D 3/007

(57) ABSTRACT

An endless belt includes a resin layer containing a resin and conductive particles, a ratio between a surface resistance value of an inner peripheral surface and a surface resistance value of an outer peripheral surface (the surface resistance value of the inner peripheral surface/the surface resistance value of the outer peripheral surface) being in a range of 0.8 to 1.2.

### CROSS-REFERENCE TO RELATED APPLICATIONS

This application is based on and claims priority under 35 USC 119 from Japanese Patent Application No. 2015-160072 filed Aug. 14, 2015.

### BACKGROUND

### Technical Field

The present invention relates to an endless belt and a method for manufacturing the endless belt.

### SUMMARY

According to an aspect of the invention, there is provided an endless belt including a resin layer containing a resin and conductive particles, a ratio between a surface resistance value of an inner peripheral surface and a surface resistance value of an outer peripheral surface (the surface resistance value of the inner peripheral surface/the surface resistance value of the outer peripheral surface) being in a range of 0.8 to 1.2.

### BRIEF DESCRIPTION OF THE DRAWINGS

An exemplary embodiment of the present invention will be described in detail based on the following figures, wherein:

FIG. 1 is a schematic partial sectional view of one end portion in an applying step according to an exemplary embodiment;

FIG. 2 is an explanatory view for describing an exemplary applying step according to the exemplary embodiment;

FIG. 3 is an explanatory view for describing the exemplary applying step according to the exemplary embodiment;

FIG. 4 is an explanatory view for describing an exemplary heating step according to the exemplary embodiment; and

FIG. 5 is an explanatory view for describing an exemplary separating step according to the exemplary embodiment.

### DETAILED DESCRIPTION

An exemplary embodiment of the present invention is hereunder described.

An endless belt according to the exemplary embodiment contains a resin (such as a polyimide resin or a polyamide-imide resin) and conductive particles (such as carbon black). In the endless belt, the ratio between a surface resistance value of its inner peripheral surface and a surface resistance value of its outer peripheral surface (the surface resistance value of the inner peripheral surface/the surface resistance value of the outer peripheral surface) is in the range of 0.8 to 1.2.

For example, existing endless belts that are applied to an intermediate transfer belt of an image forming apparatus are such that those whose ratio between a surface resistance value of their inner peripheral surface and a surface resistance value of their outer peripheral surface more closely satisfies the aforementioned range may less likely have small differences between the surface resistance values of both surfaces.

In contrast, the endless belt according to the exemplary embodiment whose ratio between the surface resistance value of the inner peripheral surface and the surface resistance value of the outer peripheral surface is within the aforementioned range is such that the differences between the surface resistance value of the inner peripheral surface and the surface resistance value of the outer peripheral surface may be less than those of endless belts whose ratio between a surface resistance value of their inner peripheral surface and a surface resistance value of their outer peripheral surface is less than 0.8 or exceeds 1.2.

When the endless belt according to the exemplary embodiment is applied to, for example, an intermediate transfer belt of an image forming apparatus, since the ratio between the surface resistance value of the inner peripheral surface and the surface resistance value of the outer peripheral surface (the surface resistance value of the inner peripheral surface/the surface resistance value of the outer peripheral surface) is in the aforementioned range, image defects, such as density irregularities, caused by transfer irregularities may tend to be reduced.

As a method for manufacturing the endless belt, the following method exists. That is, in this manufacturing method, a resin solution (containing a resin and a precursor of resin) is applied to an outer peripheral surface of a core from one end portion to the other end portion of the core as a result of ejecting the resin solution to the outer peripheral surface of the core from a solution ejecting unit while the core rotates in a peripheral direction (this applying method may also hereunder be referred to as “spiral applying method”). By this, a film of the resin solution is formed on the outer peripheral surface of the core. Thereafter, the film of the resin solution is heated and cured to form a coating. The coating is separated from the core, so that an endless belt is manufactured. It is becoming known that, when, by this method, an endless belt is manufactured by using, for example, a resin solution containing conductive particles (such as carbon black) (containing, for example, a precursor of polyimide resin as the precursor of resin), the difference between a surface resistance value of an inner peripheral surface of the endless belt and a surface resistance value of an outer peripheral surface of the endless belt may tend to be large.

When an endless belt is manufactured by the above-described method, in the process of forming a coating by heating and curing a film of resin solution formed by ejecting the resin solution containing the conductive particles to the outer peripheral surface of the core, the coating may tend to contract in an axial direction of the core. In particular, since the volatilizing speed of a solvent is higher at an outer-peripheral-surface side of the coating than at an inner-peripheral-surface side of the coating (that is, the outer-peripheral-surface side of the coating tends to be dried), the outer-peripheral-surface side may tend to contract in the axial direction of the core, as a result of which the density of the conductive particles at the inner-peripheral-surface side may tend to be high. As a result, the difference between the surface resistance value of the inner peripheral surface of the endless belt and the surface resistance value of the outer peripheral surface of the endless belt may tend to be large.

In contrast, in a method for manufacturing the endless belt according to the exemplary embodiment, as the core, a core that includes the following grooves having a depth in the range of 30 μm to 70 μm that are formed in two end portions in a direction along a peripheral direction (hereunder simply referred to as “two end portions”) is used. The resin solution containing conductive particles is ejected, and the resin solution is caused to enter the grooves to form a film on the outer peripheral surface, including the grooves, of the core. By heating the film, the film is cured to form a coating. Then, the coating is separated from the core, so that the endless belt is manufactured. As described above, since the film is formed by causing the resin solution to enter the grooves, in the process of forming the coating by heating and curing the film, the film (coating) that has entered the grooves exhibit an anchoring effect, so that contraction of both the inner-peripheral-surface side and the outer-peripheral-surface side of the coating in the axial direction of the core may tend to be reduced. As a result, the difference between the surface resistance value of the inner peripheral surface of the endless belt and the surface resistance value of the outer peripheral surface of the endless belt may tend to be reduced.

In contrast, when, by the spiral applying method, an endless belt is manufactured by using a core provided with grooves having a depth of less than 30 μm that are formed in two end portions (the case where the groove depth is 0 μm, that is, grooves are not provided in the two end portions is also included), the difference between a surface resistance value of an inner peripheral surface of the endless belt and a surface resistance value of an outer peripheral surface of the endless belt may tend to be large. In this case, since the grooves are too shallow, the anchoring effect may be less likely exhibited. In the process of forming a coating by heating and curing a film, the coating may tend to contract in the axial direction of the core.

In contrast, when a core provided with grooves having a depth exceeding 70 μm is used, gas that is produced as a result of volatilization of a solvent in a film when the film is heated may be less likely to be removed from the film. Therefore, due to stagnation of air bubbles at an interface between the film and the core, defects, such as swelling, may tend to occur. Consequently, the commercialization rate may tend to be reduced. In addition, the difference between a surface resistance value of an inner peripheral surface of the endless belt and a surface resistance value of an outer peripheral surface of the endless belt may tend to be large. This may be because, since the aforementioned air bubbles that have been produced tend to move not only to a nonproduct portion but also to a central portion of the film in the axial direction of the core, which is a product portion, the conductive particles may be clustered on one side.

From the above, according to the method for manufacturing the endless belt of the exemplary embodiment, by the above-described structure, the difference between the surface resistance value of the inner peripheral surface of the endless belt and the surface resistance value of the outer peripheral surface of the endless belt may become small.

In an endless belt formed by using a core provided with grooves having a depth in the range of 30 μm to 70 μm that are formed in two end portions and by applying a resin solution containing a conductive resin by the spiral applying method, variations in the surface resistance values in the axial direction of the core (that is, a width direction of the endless belt) may tend to be reduced.

A method for manufacturing an endless belt by using a core including recesses in two end portions and by applying a resin solution containing carbon black and a precursor of polyimide by a dip coating method is known (for example, Japanese Unexamined Patent Application Publication No. 2005-004056). However, in the above-described method, the recesses are too deep. Therefore, in the obtained endless belt, defects, such as swelling, may tend to occur. Consequently, the difference between a surface resistance value of an inner peripheral surface of the endless belt and a surface resistance value of an outer peripheral surface of the endless belt may tend to be large.

The endless belt according to the exemplary embodiment is, along with the method for manufacturing the endless belt, hereunder described with reference to the drawings. In the figures, in order to facilitate understanding, components other than those required for the description are not shown as appropriate. Components having corresponding functions are given the same reference numerals in all the figures, and may not be described.

The method for manufacturing the endless belt according to the exemplary embodiment includes an applying step, a heating step, a separating step, and a removing step as follows.

The applying step is a step in which a film is formed on an outer peripheral surface of a substantially cylindrical or columnar core by ejecting a resin solution containing conductive particles from a solution ejecting unit to the outer peripheral surface, including grooves, of the core while the core is rotated in a peripheral direction with an axial direction of the core being a direction along a horizontal direction, the grooves being provided in two end portions of the core in a direction along the peripheral direction and having a depth in a range of 30 μm to 70 μm.

The heating step is a step in which a coating is formed by heating and curing the film on the outer peripheral surface of the core.

The separating step is a step in which the coating formed by the heating step is separated from the core.

The removing step is a step in which a nonproduct portion at two end portions of the film separated from the core is removed.

Here, in the applying step, the expression “an axial direction of the core being a direction along a horizontal direction” is not limited to a direction in which the axial direction of the core and the horizontal direction match (that is, a direction in which the axial direction of the core is not at an angle with respect to the horizontal direction). The direction only needs to be a direction in which the resin solution ejected from the solution ejecting unit to the outer peripheral surface of the core reduces the movement of the resin solution towards one side in the axial direction of the core. For example, the axial direction of the core may be a direction that is at an angle (such as an acute angle not exceeding 5 degrees) with respect to the horizontal direction.

### Applying Step

First, the resin solution containing conductive particles is described.

### Resin Solution

The resin solution contains a resin or a precursor of resin, and a solvent. The resin solution further contains conductive particles. The resin or the precursor of resin that is contained in the resin solution is not particularly limited to certain resins or certain precursors of resin. From the viewpoints of, for example, strength, dimensional stability, and thermal resistance, it is desirable that the resin be a polyimide resin (hereunder may also be referred to as “PI”), a precursor of polyimide resin (polyamic acid) (hereunder may also be referred to as “PI precursor”), or a polyamide-imide resin (hereunder may also be referred to as “PAI”). From the same viewpoints, it is more desirable to select a PI or a PI precursor. As the PI, the PI precursor, and the PAI, various substances that are publicly known may be used.

When the resin solution contains a PI precursor, the PI precursor may be obtained by causing, for example, tetracarboxylic dianhydride and a diamine component to react in a solvent. Although the types of each component are not particularly limited to certain types, from the viewpoint of coating strength, it is desirable that the PI precursor be one that is obtained by causing aromatic tetracarboxylic dianhydride and an aromatic diamine component to react with each other.

Typical examples of the aromatic tetracarboxylic dianhydride include pyromellitic dianhydride, 3,3′,4,4′-biphenyl-tetracarboxylic dianhydride, 3,3′,4,4′-benzophenonetetracarboxylic dianhydride, 2,3,4,4′-biphenyl-tetracarboxylic dianhydride, 2,3,6,7-naphthalenetetracarboxylic dianhydride, 1,2,5,6-naphthalenetetracarboxylic dianhydride, 2,2-bis(3,4-dicarboxyphenyl) ether dianhydride, or tetracarboxylic acid esters thereof, or mixtures of the aforementioned tetracarboxylic acids.

Examples of the aromatic diamine components include paraphenylenediamine, metaphenylenediamine, 4,4′-diaminodiphenyl ether, 4,4′-diaminodiphenylmethane, benzidine, 3,3-dimethoxybenzidine, 4,4-diaminodiphenylpropane, 2,2-bis[4-(4-aminophenoxy)phenyl]propane.

When the resin solution contains a PI, the PI may be, for example, one (polyimide resin) that is solvent-soluble and that is formed by imidization by causing publicly known tetracarboxylic dianhydride and a publicly known diamine component to react with each other in a solvent. The combination of the tetracarboxylic dianhydride and the diamine component is selected such that the PI that has been formed by imidization is solvent-soluble. The term “solvent-soluble” means that 1 mass % or greater of the PI is dissolved with respect to a solvent described below.

The PAI is obtained by combining an acid anhydride, such as trimellitic anhydride, ethylene glycol bisanhydrotrimellitate, propylene glycol bisanhydrotrimellitate, pyromellitic anhydride, benzophenonetetracarboxylic anhydride, or 3,3′,4,4′-biphenyltetracarboxylic anhydride, with the aforementioned diamines, and by causing a polycondensation reaction of equal molar quantities to occur. Since the PAI contains an amide group, even if an imidization reaction progresses, it tends to be dissolved by the solvent. Therefore, it is desirable that the PAI be formed by imidization by 100%.

As the solvent that is contained in the resin solution, an aprotic polar solvent, such as N-methylpyrrolidone, N, N-dimethyl acetamide, or acetamide, is used.

For example, the concentration and the viscosity of the resin solution are not particularly limited to certain concentrations and viscosities. However, in the exemplary embodiment, the solid component concentration of the solution is desirably in the range of 10 mass % to 40 mass %, and the viscosity is desirably in the range of 1 Pa·s to 100 Pa·s.

The resin solution contains conductive particles. For the conductive particles, for example, carbon substances, such as carbon black, carbon fiber, carbon nanotubes, or graphite; metals, such as copper, silver, or aluminum, or alloys thereof; conductive metallic oxides, such as tin oxides, indium oxides, or antimony oxides; or whiskers made of potassium titanate; may be used. Of these, from the viewpoint of, for example, dispersion stability in the liquid and price, it is desirable to use carbon black.

In the exemplary embodiment, the term “conductive” refers to a volume resistance that is less than 10⁷ Ωcm.

Examples of carbon black include Ketjen black, oil-furnace black, channel black, and acetylene black. For the carbon black, only one type from among these types may be used, or two or more types from among these types may be used in combination.

Examples of a method for dispersing the conductive particles include publicly known methods using, for example, a ball mill, a sand mill (bead mill), or a jet mill (opposing collision-type disperser). As a dispersing agent, for example, a surfactant or a leveling agent may be added. The dispersion concentration of the conductive particles (the number of conductive particles contained in the resin solution) may be in the range of 10 parts by mass to 40 parts by mass with respect to 100 parts by mass of the resin or the resin precursor; is desirably in the range of 15 parts by mass to 35 parts by mass with respect to 100 parts by mass of the resin or the resin precursor; and is more desirably 20 parts by mass to 30 parts by mass with respect to 100 parts by mass of the resin or the resin precursor.

Next, a method for forming a film of the resin solution containing conductive particles on the outer peripheral surface, including the grooves, of the core is described. In the description below, a method that uses a resin solution containing a PI precursor is described as an example.

As the method for forming the film of the resin solution containing conductive particles on the outer peripheral surface of the core, the spiral applying method is used. By the spiral applying method, the resin solution containing conductive particles is applied to the outer peripheral surface, including the grooves that are formed in two end portions of the core, of the core to form the film.

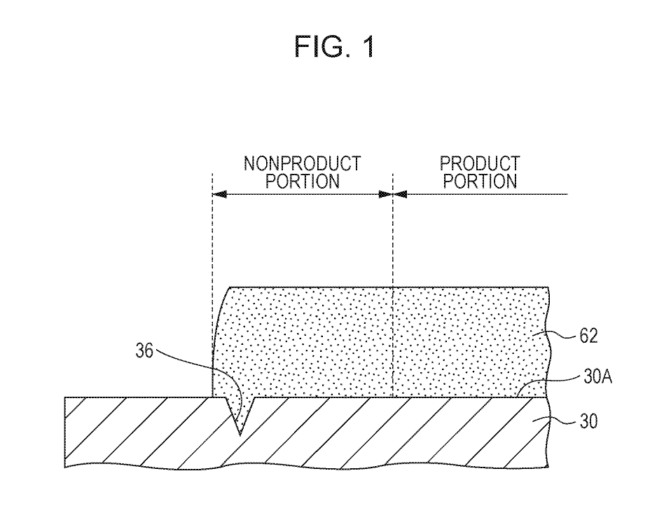

FIG. 1 is an axial sectional schematic view of one end portion of a core 30 on which a film 62 is formed. As shown in FIG. 1, by the applying step according to the exemplary embodiment, the resin solution containing conductive particles is caused to enter a groove 36 provided in the end portion of the core 30, to form the film 62 of the resin solution containing conductive particles on an outer peripheral surface 30A, including the groove 36, of the core 30. As shown in FIG. 1, the groove 36 that is formed in the core 30 is provided in a region of the core 30 where the film 62 is formed corresponding to a nonproduct portion of the endless belt. The depth of the groove 36 is in the range of 30 μm to 70 μm.

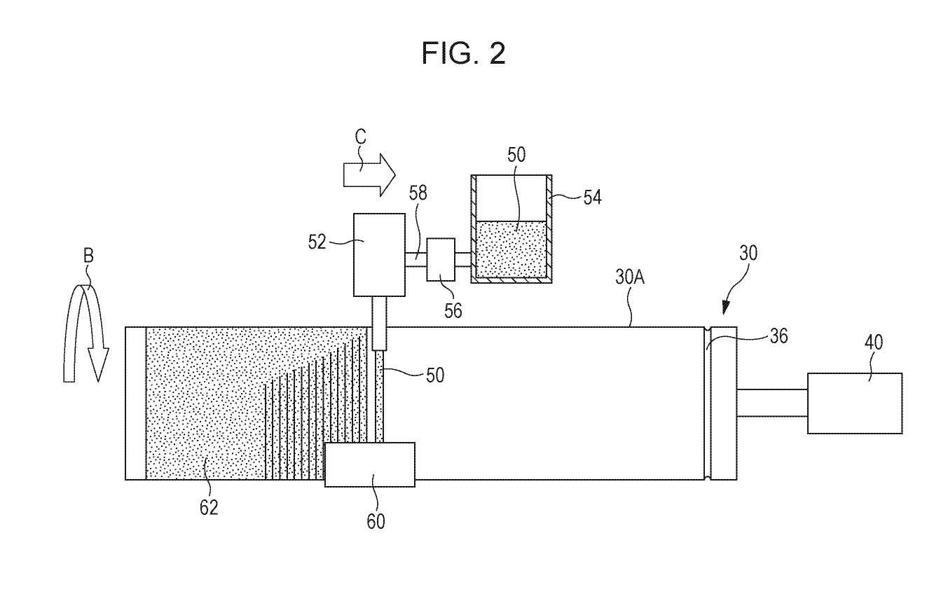

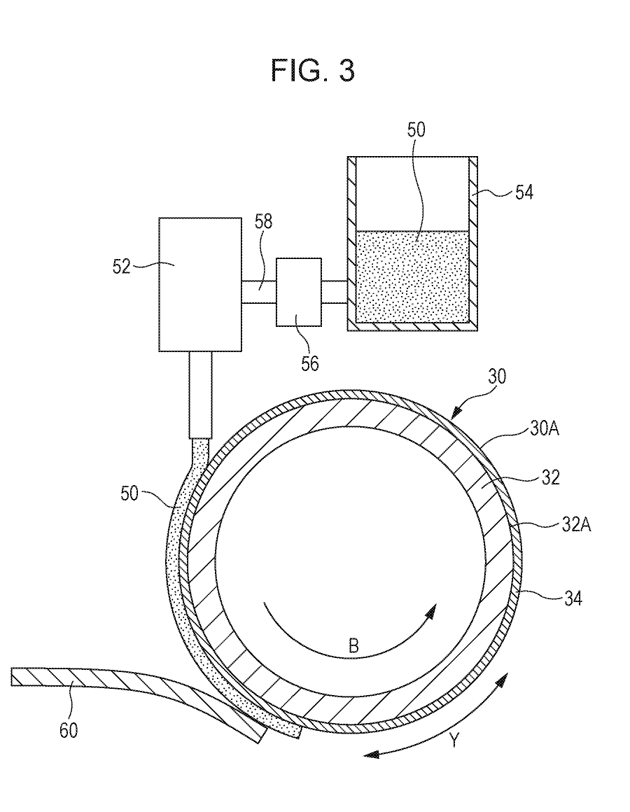

FIGS. 2 and 3 are schematic views each showing an exemplary spiral applying method. As shown in FIG. 2, the groove 36 is formed in one of the end portions of the substantially cylindrical or columnar core 30. A groove (not shown) is also formed in the other end portion of the core 30 at a side that is covered by the film 62. In the spiral applying method, as shown in FIGS. 2 and 3, a resin solution 50 is applied to the outer peripheral surface 30A of the substantially cylindrical or columnar core 30 by ejecting the resin solution 50 from a solution ejecting device 52 (exemplary solution ejecting unit) while the core 30 is rotated around an axis (in the direction of arrow B) by a rotary device 40 with the axial direction of the core 30 being a direction along the horizontal direction. A pump 56 causes the resin solution 50 to be supplied to the solution ejecting device 52 from a tank 54 that stores the resin solution 50 through a supply pipe 58. The resin solution 50 adhered to the outer peripheral surface 30A of the core 30 is smoothened by a spatula 60.

As shown in FIG. 3, the core 30 includes a substantially cylindrical or columnar core body 32 and a separation layer 34 that is formed on an outer peripheral surface 32A of the core body 32. In FIG. 3, peripheral directions of the core body 32 (the core 30) are indicated by a double-headed arrow Y.

As the material of the core body 32 that is used in the exemplary embodiment, for example, a metal, such as aluminum or stainless steel, is used. The width of the core body 32 (the core 30) (the length in the axial direction of the core) is greater than the width of the endless belt to be formed (the length in the axial direction of the core). For example, in order to provide a sufficient region for a nonproduct portion that is produced at end portions of the endless belt, it is desirable that the width of the core body 32 (the core 30) (that is, the length in the axial direction of the core) be larger than the width of the endless belt to be formed by, for example, 10% to 40%. The peripheral length of the core body 32 (the core 30) (that is, the length in the peripheral directions of the core) may be, for example, greater than or equal to the length of the endless belt to be formed.

The depth of the grooves 36 in the two end portions of the core 30 that is used in the exemplary embodiment is in the range of 30 μm to 70 μm. From the viewpoint of reducing the difference between the surface resistance value of the inner peripheral surface of the endless belt and the surface resistance value of the outer peripheral surface of the endless belt, it is desirable that the depth of the grooves 36 be in the range of 50 μm to 70 μm.

From the same viewpoint, the opening width of the grooves 36 may be, for example, in the range of 30 μm to 150 μm.

An example of a method for forming the grooves 36 in the two end portions of the core is a method in which, by using a lathe or the like, the core body 32 (the core 30) is rotated in a peripheral direction, and a cutting tool is brought into contact with the rotating core body 32 (the core 30) to cut and form the grooves therein. The depth and the opening width of the grooves 36 may be adjusted in accordance with, for example, the shape and size of the cutting tool for forming the grooves 36, and the pressure when the cutting tool contacts the outer peripheral surface of the core body 32 (the core 30).

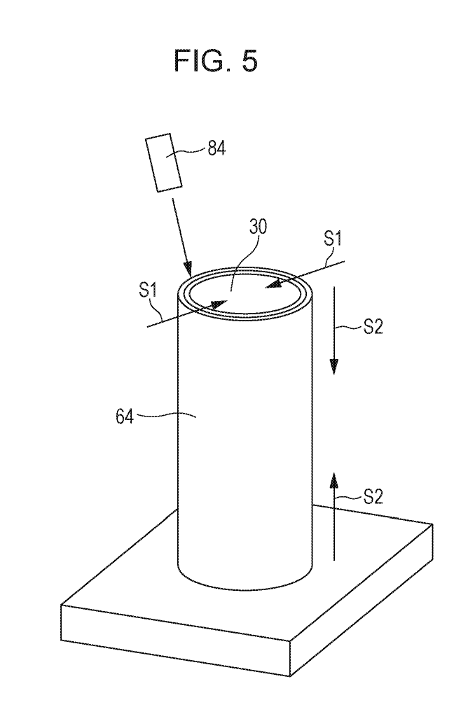

The sectional shape of the grooves 36 in the axial section of the core 30 is not particularly limited to certain sectional shapes. Examples of the sectional shape of the grooves 36 include a U shape and a V shape. From the viewpoint of, for example, making it easier to separate a coating 64 from the core 30 after heating and curing the film 62, the sectional shape of the grooves 36 may be V-shaped as shown in FIG. 5. The number of grooves 36 in the two end portions of the core 30 may be one or two or more.

The separation layer 34 may be formed by coating the outer peripheral surface 32A of the core body 32 with a material selected from, for example, inorganic compounds, silicone resins, and fluorine-based resins. The application of any of the aforementioned materials on the outer peripheral surface 32A of the core body 32 is performed, for example, by, after a separating agent made of any of the aforementioned materials has been applied to the outer peripheral surface 32A of the core body 32, heating the core body 32 to perform baking thereof. The separation layer 34 may be formed by, for example, plating the outer peripheral surface 32A of the core body 32 with chromium, nickel, or the like. In the exemplary embodiment, even if the core 30 includes the separation layer 34 on the core body 32, the depth of the grooves 36 in the two end portions of the core 30 is controlled in the range of 30 μm to 70 μm.

The solution ejecting device 52 and the spatula 60 are supported so as to be movable in the axial direction of the core 30 (in the direction of arrow C). By ejecting the resin solution 50 while the solution ejecting device 52 and the spatula 60 move in the axial direction of the core 30 (in the direction of arrow C) with the core 30 being rotated at a preset rotational speed, the resin solution 50 is spirally applied to the surface of the core 30, and is smoothened by the spatula 60, so that spiral streaks are eliminated, and the film 62 without seams is formed. The film thickness of the film 62 is set to a predetermined film thickness such that the film thickness of the endless belt that has become a product is, for example, in the range of 50 μm to 150 μm.

### Drying Step

After the applying step, the film 62 is heated and cured. Before the film 62 is cured, a drying step of drying the film 62 may be performed. Here, the term “drying” refers to heating a solvent contained in the film 62 to evaporate the solvent until the amount of solvent is less than or equal to a predetermined amount.

More specifically, it is desirable that the film 62 be heated and dried while the core 30 is rotated by the aforementioned rotary device 40. It is desirable that the heating condition be such that the heating is performed for 10 minutes to 60 minutes at a temperature in the range of 80° C. to 200° C. The higher the temperature is, the shorter the heating time and the drying time may be. It is effective to expose the film 62 to hot air during the heating. The heating may gradually increase the temperature, or may increase the temperature at a certain rate. During the heating, in order to make it possible to reduce any drooping of the film, the core 30 may be rotated, for example, in the range of 5 rpm to 60 rpm.

### Heating Step

In the heating step, the film 62 is heated and cured.

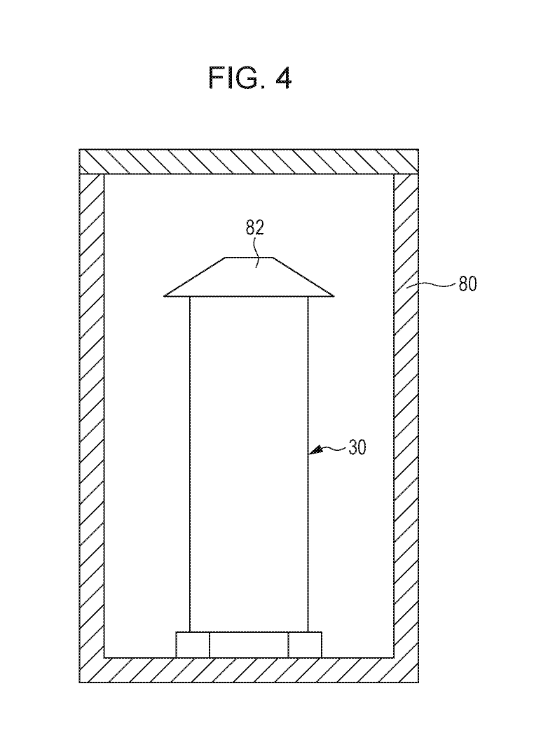

The heating step is a step that is performed when the resin solution contains a material that is cured when, for example, a PI precursor is heated. When the resin solution contains a PI precursor, in the heating step, for example, as shown in FIG. 4, the core 30 on whose outer peripheral surface the film 62 has been formed is placed in a heating furnace 80 and heated. The heating temperature may be in the range of 250° C. to 450° C., and is desirably in the range of 300° C. to 350° C. The heating time may be in the range of 20 minutes to 60 minutes. By heating (firing) the film 62 of the PI precursor liquid, an imidization reaction occurs, and the film 62 is cured. Then, as shown in FIG. 5, the coating 64 of PI (endless belt) formed by curing the film 62 is formed. During the heating reaction, it is desirable to heat the film 62 by gradually increasing the temperature or by gradually increasing the temperature at a certain rate before the temperature reaches a final heating temperature.

Since, at the aforementioned high temperatures, a roller of the rotary device has low thermal resistance, in the above-described heating step, the core may be lowered from the rotary device and placed in the heating furnace 80. Ordinarily, with the axial direction of the core 30 being along a gravity direction, that is, with the core 30 being vertically set, the core 30 is placed in the heating furnace 80. In order to suppress temperature irregularities in the heating furnace 80, it is desirable that the heating furnace 80 have a structure that blows out hot air from above the vertically set core 30. In order to prevent an upper portion of the core from being directly exposed to the hot air, as shown in FIG. 4, a shielding member 82 that shields the upper portion of the core from wind may be installed. As long as the shielding member 82 is capable of covering one end of the core, the shape of the shielding member 82 is not particularly limited to certain shapes.

In the exemplary embodiment, by performing the drying step and the heating step, in the process of heating and curing the film 62 and forming the coating 64, the solvent in the film 62 evaporates, and the coating 64 tends to contract. Of the contractions of the coating 64, the contraction of the coating 64 in the direction towards the inner side in a radial direction of the core 30 (see arrows S1 in FIG. 5) is restricted by the core 30. The contraction in the direction along the axial direction of the core 30 (see arrows S2 in FIG. 5) is reduced as a result of the inner-peripheral-surface side and the outer-peripheral-surface side of the core 30 being subjected to movement resistance of the core in the axial direction by an anchoring effect of the coating 64 in the grooves 36 caused by the formation of the coating 64 with the film 62 that has entered the grooves 36 formed.

### Separating Step

In the separating step, the coating 64 formed by the heating step is separated from the core 30.

In the separating step, for example, after the heating step has ended, the core 30 is taken out from the heating furnace 80 and is cooled to room temperature, after which, as shown in FIG. 5, an air injecting unit 84 injects air into a gap between the coating 64 and an end portion in the axial direction of the outer peripheral surface 30A of the core 30. By this, the coating 64 is pulled off from the core 30, so that the endless belt is formed. For example, after the heating step has ended, the core is taken out from the heating furnace 80 and is cooled to room temperature, after which, by injecting air into the gap between the coating 64 and the end portion in the axial direction of the outer peripheral surface 30A of the core 30, the coating 64 is pulled off from the core 30, so that the endless belt is formed.

### Removing Step

Protrusions corresponding to the grooves 36 are formed on an inner-peripheral-surface side of a nonproduct portion of the endless belt obtained by separating the coating 64 from the core 30. In the removing step, the nonproduct portion including the protrusions corresponding to the grooves 36 in the two end portions of the endless belt is removed. By this, the endless belt including only the product portion is obtained.

When the endless belt is applied to an intermediate transfer belt, for example, a step of forming a hole or a step of forming a rib may be performed as appropriate.

The endless belt that is formed by the method for manufacturing the endless belt according to the exemplary embodiment is applied to, for example, an intermediate transfer belt. The intermediate transfer belt is a transfer member to which an image from a photoconductor is transferred and that transfers the image to a recording medium. The intermediate transfer belt is used in an image forming apparatus, such as an electrophotographic copying machine or a laser printer.

The endless belt according to the exemplary embodiment is not limited in its use to the intermediate transfer belt of the image forming apparatus. The endless belt according to the exemplary embodiment may be applied to, for example, a fixing belt, a sheet transporting belt, or other types of endless belts. The endless belt according to the exemplary embodiment may be applied to any of the above-described types of belts as an endless belt including a single body. Alternatively, the endless belt may be applied to any of the above-described types of belts as a multilayer endless belt including various functional layers, such as the separation layer and an elastic layer, with the endless belt serving as a base.

Although the method for manufacturing the endless belt according to the exemplary embodiment is described above, the exemplary embodiment is not limited to the forms shown in FIGS. 1 to 5.

Although, in the description above, the case in which the resin solution contains a PI precursor is described as an example, the present invention is not limited thereto. For example, when the resin contained in the resin solution is PAI, the coating is formed by curing the resin by the drying step of drying a solvent. In this case, the drying step corresponds to the heating step according to the exemplary embodiment.

The surface resistance values of the endless belt according to the exemplary embodiment are hereunder described. The surface resistance values are described without using symbols.

In the endless belt according to the exemplary embodiment, the ratio between the surface resistance value of the inner peripheral surface and the surface resistance value of the outer peripheral surface is in the range of 0.8 to 1.2. From the viewpoint of making smaller the difference between the surface resistance value of the inner peripheral surface and the surface resistance value of the outer peripheral surface, the ratio is desirably in the range of 0.95 to 1.05.

In the endless belt according the exemplary embodiment, as described above, the difference between the surface resistance value of the inner peripheral surface and the surface resistance value of the outer peripheral surface is reduced. Differences in the surface resistance values of the inner peripheral surface and those of the surface resistance values of the outer peripheral surface in the width direction are also reduced. As the differences between the surface resistance values of the endless belt in the width direction, the ratio between the minimum surface resistance value and the maximum surface resistance value (minimum value/maximum value) of the inner peripheral surface and that of the outer peripheral surface in the width direction are desirably in the range of 0.6 to 1.0, and are more desirably in the range of 0.8 to 1.0.

The surface resistance values of the inner and outer peripheral surfaces of the endless belt are desirably in the range of 1.0×10⁸Ω to 1.0×10¹³Ω, and are more desirably in the range of 1.0×10⁹Ω to 1.0×10¹²Ω.

The surface resistance values of the inner and outer peripheral surfaces of the endless belt according to the exemplary embodiment are measured by the following method.

A voltage application electrode and a current measurement electrode and a guard electrode that is larger than the voltage application electrode and the current measurement electrode and that is wide enough to include the voltage application electrode and the current measurement electrode are provided. With the distance between the voltage application electrode and the current measurement electrode being 10 mm, the endless belt is inserted among the voltage application electrode, the current measurement electrode, and the guard electrode. A voltage of 200 V is applied among the voltage application electrode, the current measurement electrode, and the guard electrode. A current I after 10 seconds from the start of the application of the voltage is measured with an ammeter (R8340A: digital ultra-high resistance/micro-ammeter, manufactured by Advantest Corporation). By using the following formula, a surface resistance Rs (Ω) is calculated. The measurement gives an average value obtained by measuring five locations on each surface:

Rs=200 (V)/I(A).

### EXAMPLES

Although the exemplary embodiment is hereunder described in more detail by way of examples, the exemplary embodiment is not limited to these examples. In the description below, unless otherwise particularly stated, “part” and “%” are both based on mass.

### Preparation of Application Liquid

N-methylpyrrolidone is used as a solvent. With respect to 100 parts by mass of polyamic acid, 27 parts by mass of carbon black (manufactured by Orion Engineered Carbons; Special Black 4 (tradename)) is dispersed, and a polyamic acid solution (manufactured by JFE Chemical Corporation; JIV300H (tradename)) having a solid component concentration of 22 mass % is used as an application liquid.

### Example 1

A substantially cylindrical stainless-steel core provided with grooves having a depth of 62 μm in a peripheral direction in two end portions of the core (that is, at locations corresponding to locations that are 20 mm from ends of a film corresponding to a nonproduct portion of an endless belt).

As shown in FIGS. 2 and 3, by using a spiral applying device, the application liquid prepared above is applied to an outer peripheral, including the grooves, of the core, and is dried at 140° C. for 30 minutes. Then, the application liquid is further heated at 320° C. for one hour to form a coating. After the heating has ended, the coating is separated from the core, so that an endless belt (1) of Example 1 is formed. The surface resistance values of the inner and outer peripheral surfaces of the endless belt are measured by the aforementioned method. The results are shown in Table 1.

### Example 2

An endless belt (2) is formed by performing the same procedure as in Example 1 except that a core that is used differs from the core used in Example 1 in that grooves having a depth of 35 μm are formed in a peripheral direction in two end portions of the core (locations corresponding to those in the core used in Example 1). The surface resistance values of the inner and outer peripheral surfaces of the endless belt are measured by the aforementioned method. The results are shown in Table 1.

### Comparative Example 1

An endless belt (C1) is formed by performing the same procedure as in Example 1 except that a substantially cylindrical stainless-steel that is used differs from the core used in Example 1 in that the core is formed into one whose Ra=2.0 μm by performing blasting using spherical beads in a peripheral direction in two end portions of the core (locations corresponding to those in the core used in Example 1). The height of an uneven portion after the blasting formed on the two end portions of the core is 13 μm. The surface resistance values of the inner and outer peripheral surfaces of the endless belt are measured by the aforementioned method. The results are shown in Table 1.

### Comparative Example 2

An endless belt (C2) is formed by performing the same procedure as in Example 1 except that a core that is used differs from the core used in Example 1 in that grooves having a depth of 10 μm are formed in a peripheral direction in two end portions of the core (locations corresponding to those in the core used in Example 1). The surface resistance values of the inner and outer peripheral surfaces of the endless belt are measured by the aforementioned method. The results are shown in Table 1.

### Comparative Example 3

An endless belt (C3) is formed by performing the same procedure as in Example 1 except that a core that is used differs from the core used in Example 1 in that grooves having a depth of 82 μm are formed in a peripheral direction in two end portions of the core (locations corresponding to those in the core used in Example 1). The two end portions and the central portion of the endless belt (C3) bulge. Since the grooves are too deep, gas may no longer be easily removed. The surface resistance values of the inner and outer peripheral surfaces of the endless belt are measured by the aforementioned method. The results are shown in Table 1.

TABLE 1

| | | | Ratio between Surface | |
|---|---|---|---|---|
| | Surface Resistance | | Resistance Values | |
| | Value | | Inner | Minimum |
| | Inner | Outer | Peripheral | Value/Maximum |
| | Peripheral | Peripheral | Surface/Outer | Value in |
| | Surface | Surface | Peripheral | Width |
| | (Ω) | (Ω) | Surface | Direction |
| Example 1 | 1.05 × 10⁹ | 1.03 × 10⁹ | 1.02 | 0.93 |
| Example 2 | 8.86 × 10⁸ | 9.05 × 10⁸ | 0.98 | 0.86 |
| Comparative | 1.34 × 10⁹ | 1.76 × 10⁹ | 0.76 | 0.55 |
| Example 1 | | | | |
| Comparative | 1.04 × 10⁹ | 1.34 × 10⁹ | 0.78 | 0.57 |
| Example 2 | | | | |
| Comparative | 8.32 × 10⁸ | 1.22 × 10⁹ | 0.68 | 0.59 |
| Example 3 | | | | |

The results show that the differences between the surface resistance values of the inner and outer peripheral surfaces in the examples are smaller than those in the comparative examples.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An endless belt comprising:
a resin layer containing a resin and conductive particles, a ratio between a surface resistance value of an inner peripheral surface and a surface resistance value of an outer peripheral surface (the surface resistance value of the inner peripheral surface/the surface resistance value of the outer peripheral surface) being in a range of 0.8 to 1.2.

2. The endless belt according to claim 1, wherein the resin is a polyimide resin or a polyamide-imide resin, and
wherein the conductive particles are carbon black.

3. A method for manufacturing an endless belt comprising:
applying in which a film is formed on an outer peripheral surface of a substantially cylindrical or columnar core by ejecting a resin solution containing conductive particles from a solution ejecting unit to the outer peripheral surface, including grooves, of the core while the core is rotated in a peripheral direction with an axial direction of the core being a direction along a horizontal direction, the grooves being provided in two end portions of the core in a direction along the peripheral direction and having a depth in a range of 30 μm to 70 μm;
heating in which a coating is formed by heating and curing the film on the outer peripheral surface of the core;
separating the coating formed by the heating from the core; and
removing a nonproduct portion at two end portions of the coating separated from the core.

4. The method according to claim 3, wherein the resin solution contains a polyimide resin or a precursor of the polyimide resin or a polyamide-imide resin, and
wherein the conductive particles are carbon black.
